(19) United States
(12) Patent Application Publication
(10) Pub. No.: US 2014/0100824 A1
(43) Pub. Date: Apr. 10, 2014

(54) SYSTEM AND METHOD OF PROVIDING AN AUTOMATED DESIGN AND MODIFICATION OF AIRCRAFT ELECTRICAL SYSTEMS

(71) Applicant: Douglas Andrew Bess, Miami, FL (US)

(72) Inventor: Douglas Andrew Bess, Miami, FL (US)

(21) Appl. No.: 13/649,106

(22) Filed: Oct. 10, 2012

(51) Int. Cl. G06F 17/50

(52) U.S. Cl. CPC G06F 17/5095
USPC 703/1

(57) ABSTRACT

The present invention is a computer program product comprised of a non-transitory computer usable medium having a computer readable code embodied thereon provided to implement a method and system of designing and modifying aircraft electrical systems. The process provides for an automated electrical circuiting and production of detailed engineering “ECAD” drawings from several differing views of particular data. The present product provides a collaborative environment between management, engineers and technicians. It allows end user reporting that provides the entire organization with the ability to manage, search and view all information contained in the aircraft wiring diagram(s) for an entire project or electrical system.

### CROSS-REFERENCES TO RELATED APPLICATIONS

This application is a non-provisional patent application claiming the benefit of an earlier filed provisional application pursuant to 37 C.F.R. §1.53(c). The U.S. provisional patent application was filed on Oct. 10, 2011 and was assigned Ser. No. 61/545,402. The applications name the same inventor.

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of computer software design systems. More specifically, the present invention comprises a computer software product that executes a method and system for designing and modifying aircraft electrical systems.

2. Description of the Related Art

Various systems and methods exist for computer-aided design and drafting (CADD) and electronic design automation (EDA or ECAD). CADD software provides a system in which a user can more efficiently and effectively operate a design process.

Oftentimes, CADD software is utilized for drafting models, such as a particular component part of a device. Additionally, the software can be utilized for technical and engineering drawings, including input-tools to streamline the design process. These systems are extremely useful in many different industries, including, but not limited to, industrial and architectural design and prosthetics. ECAD operates to allow a user to design electronic systems specifically.

Currently, the aviation modification and completion industry does not have an adequate ECAD product for designing and modifying aircraft electrical systems. More particularly, current software products utilized fail to provide effective design and drawing tools, design and drawing automation, automated error checking and reporting abilities and documentation. More specifically, the current software products do not provide a centralized structured database that can efficiently interact with an independent user station in real time as updates are made to a design or drawing.

Therefore, what is needed is a system and method of designing and modifying aircraft electrical systems with the features as described herein.

### SUMMARY OF THE PRESENT INVENTION

The present invention is a computer program product comprised of a non-transitory computer usable medium having a computer readable code embodied thereon provided to implement a method and system of designing and modifying aircraft electrical systems. The process provides for an automated electrical circuiting and production of detailed engineering “ECAD” drawings from several differing views of particular data. The present product provides a collaborative environment between management, engineers and technicians, it allows end user reporting that provides the entire organization with the ability to manage, search and view all information contained in the aircraft wiring diagram(s) for an entire project or electrical system.

### BRIEF DESCRIPTION OF THE SEVERAL VIEWS OF THE DRAWINGS

FIG. 1 is a block diagram showing the present computer program product.

FIG. 2 is a screen shot showing the organization on the engineering workstation user interface in the present computer program product.

FIG. 3 is a screen shot showing the organization of the design data in the present computer program product.

FIG. 4 is a screen shot showing the organization of the design data in the present computer program product.

FIG. 5 is a screen shot showing the organization of the design data in the present computer product.

REFERENCE NUMERALS IN THE DRAWINGS

| | | | |
|---|---|---|---|
| 10 | computer program product | 12 | engineering workstation |
| 14 | server | 16 | schematic drawing |
| 18 | report output | 20 | centralized database |
| 22 | explorer window | 24 | master library |
| 26 | component part | 28 | drawing workspace |
| 30 | shape view | 32 | materials list |
| 34 | drawing reference interface | 36 | indicators |
| 38 | database architecture | 40 | hierarchical structure |

### DETAILED DESCRIPTION OF INVENTION

The present invention is a computer program product 10 comprised of a non-transitory computer usable medium having a computer readable code embodied thereon provided to implement a method and system of designing and modifying aircraft electrical systems. The process provides for an automated electrical circuiting and production of detailed engineering “ECAD” drawings from several differing views of particular data. The present product provides a collaborative environment between management, engineers and technicians. It allows end user reporting that provides the entire organization with the ability to manage, search and view all information contained in the aircraft wiring diagram(s) for an entire project or electrical system.

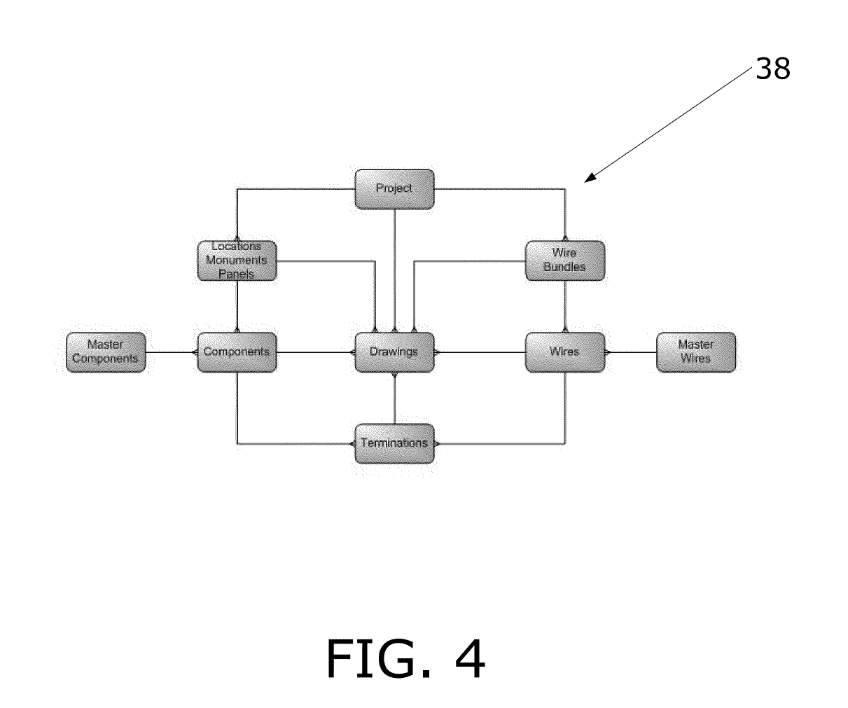

The present computer program product's centralized database is designed to mimic the manner in which an aircraft electrical system is shown on an aircraft wiring diagrams. The present database architecture 38 is illustrated in FIG. 4. The data structure contained in the centralized database models the manner in which information is physically contained within the wiring diagrams and the processes used to create or modify an aircraft electrical system within the aviation completion/modification industry. The design of the database architecture 38 is therefore specialized for aircraft electrical systems so that performance is optimized and user interface is intuitive as it follows well understood aviation workflows.

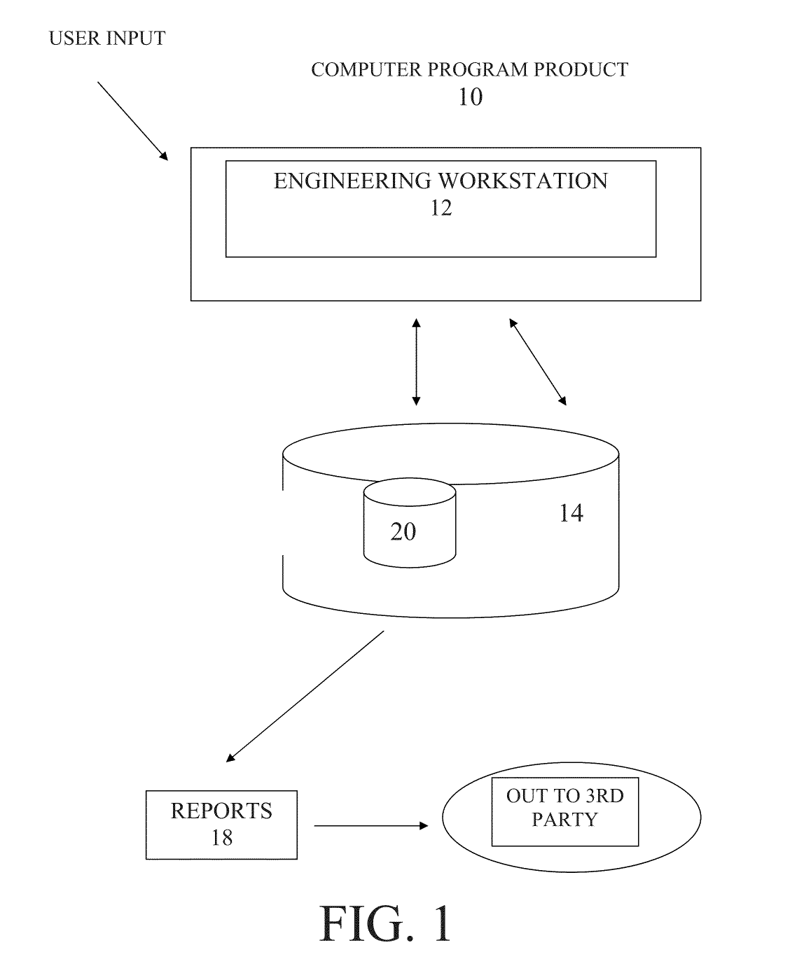

In a preferred embodiment, as illustrated in FIG. 1, a user, such as a client or engineer, can input raw data in a digital format into an engineering workstation 12 to generate detailed electrical engineering specifications and information. In the alternative, the user can begin with known schematic drawings which can be modified or manipulated to correspond with the desired specifications. The inputted data and/or existing data are stored in a centralized database 20, located on server 14, which stores a multitude of data associated with the schematic drawings and component parts.

A simplified version of the systems architecture is provided in FIG. 1. The five main components of the present product 10 are: (1) Microsoft Visio™ 2010 (provided on local storage at each engineering workstation 12), (2) Visual Engineer EEMS™ client (provided on local storage at each engineering workstation 12), (3) Microsoft SQL™ server (provided on centralized database 20 on server 14) and (4) Visual Engineer EEMS™ database (provided on centralized database 20 on server 14). The present product 10 can optionally integrate with other existing document management systems if needed by the client without any modifications required to either system.

The present computer program product 10 allows avionic engineers to use a standard installation of a commercial diagramming program which uses vector graphics to create diagrams (one such computer program is Microsoft Visio™ Professional, a product of Microsoft Corporation, headquartered in Redmond, Wash.) to easily design electrical engineering drawings. The drawings created by a user using the present product 10 update on a centralized database 20 within the Structured Query Language (“SQL”) server by way of the computer program products engine. This ensures that all equipment attributes, wire attributes and other information remain consistent within the project drawings. Additionally it provides real-time reporting for the end-user requiring this information. The created drawings are stored on any local or network drive that is available for use by an engineer.

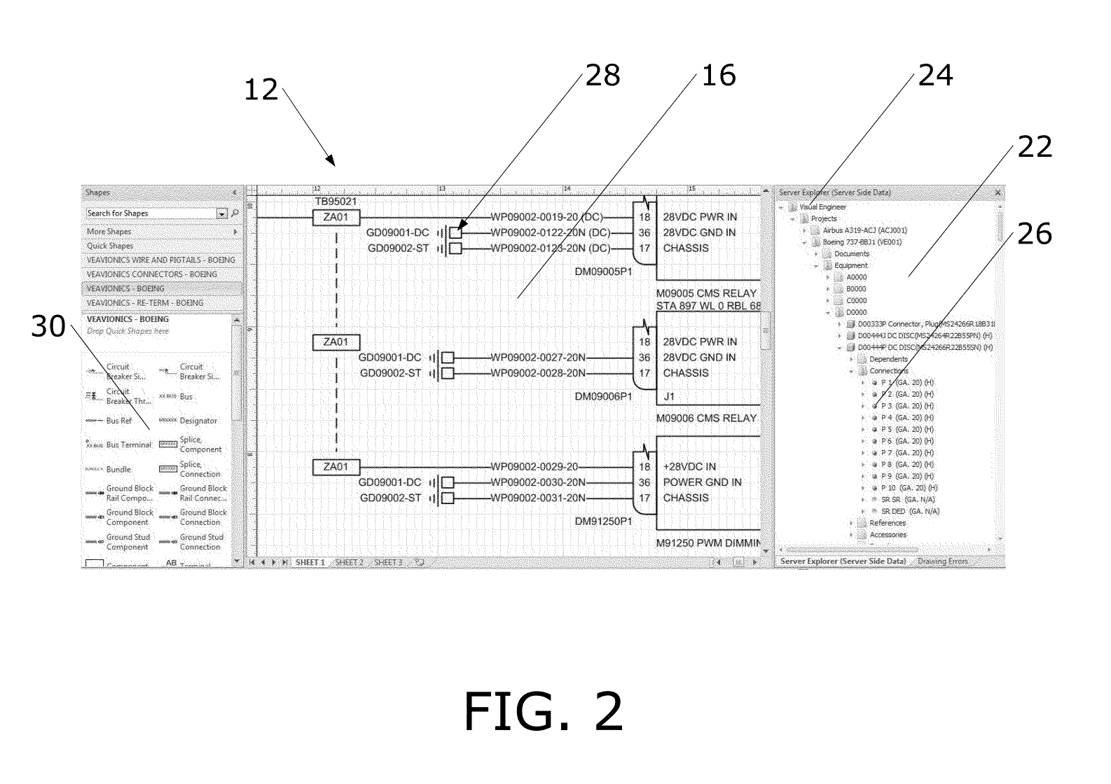

To provide further detail the user preferably begins with a series of schematic drawings stored on a centralized database 20 located on a server 14. The user selects a schematic drawing to view. FIG. 2 illustrates a representative screen shot of engineering workstation 12 wherein the user has selected a schematic drawing 16. The present computer program product 10 allows the user to view the selected schematic drawing 16 within drawing workspace 28, the explorer window 22 (including master library 24) and the shape view 30, simultaneously.

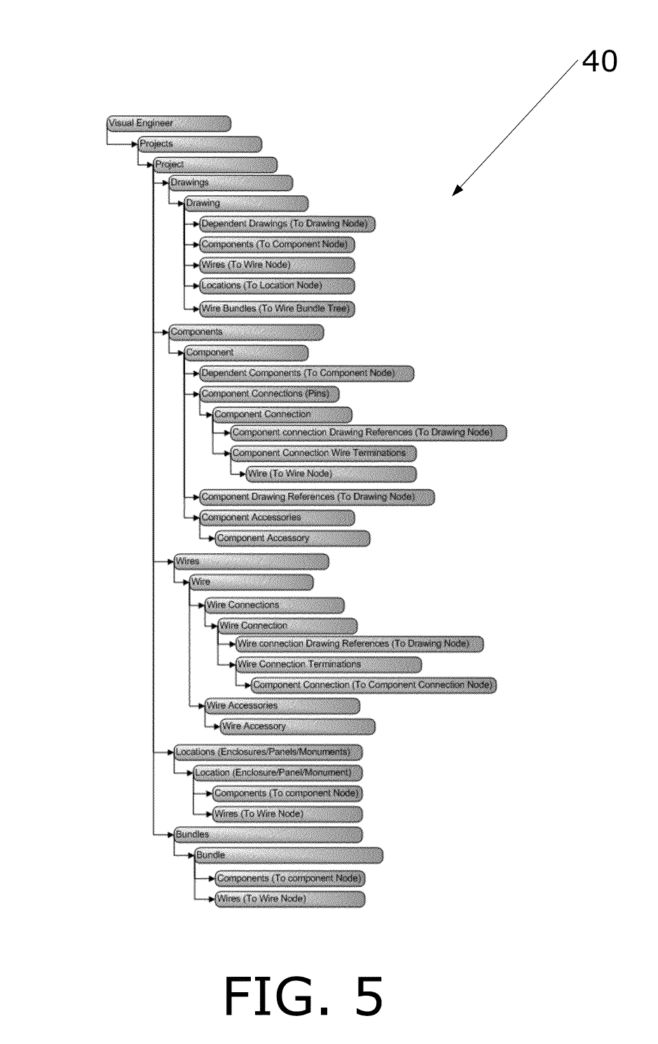

Explorer window 22 provides access to all database Objects 26 (or component parts) within the master library 24. The database objects 26 are listed in a hierarchical and consistent order. A more detailed view of the hierarchical structure 40 within explorer window 22 is illustrated in FIG. 5. The user can navigate the electrical design information contained within each schematic drawing for each project, the master component and wire libraries. The user is able to search through the entire design without having to open a schematic drawing to access a component and/or wire. Master library 24 within centralized database organizes and presents the data to the user based on the process used within the aviation modification industry. Thus, the user can efficiently select a component part and/or wire from the master library 24 within centralized database.

Returning to FIG. 2, explorer window 22 (containing master library 24) allows the user, while working on a selected schematic drawing 16 to locate and select a component part 26 quickly and efficiently. The master library 24, residing on the centralized database 20 includes common data associated with each component part 26. Thus, when the user selects a desired component part 26, the user can drag and drop that component part 26 onto the currently selected schematic drawing 16 in drawing workspace 28.

The shape view workspace 30 provides all of the intelligent shapes that are associated with each database object.

The drawing workspace 28 provides a view of selected schematic drawing 16 with database objects and their associations (or attributes) using custom shapes and rules. The selected schematic drawing 16 can be uploaded onto the user's engineering workstation 12 local storage or reside on the server 14 Each schematic drawing 16 represents different views of relevant data and contain embedded intelligent objects. The embedded objects provide a two-way linking relationship between the data the user modifies on the drawings and a centralized database 20 (illustrated in FIG. 1). As the user manipulates one drawing the information is pushed to the database to reflect the design. This information in turn is pulled from the centralized database 20 to automatically update each drawing (stored in server 14) so that all drawings used in the project are synchronized. Thus, the overall electrical design resides in the centralized database 20, and the drawings are just sub-sets of this data represented in schematic form.

The process is fully automated in that the drawings are automatically synchronized across a project. The application allows for a user interface that is easy and efficient to use due to the fact that the three work areas are visible together and function in conjunction with one another. For example the drag and drop operation allows for the automated selection and connection of a virtual object (e.g. component part and/or wires). A user is able to select an electrical component or their attributes, drag that electrical component/attributes to the drawing workspace 28 release it. When the component part 26 is released, the desired attributes of the component part 26 are automatically drawn on the field of the drawing 16 and the centralized database 20 is updated to store the relationship of the equipment and the drawing 16. This functionality can allow the end-user to create many associations between two electrical components and/or attributes thereof. For example, a wire may be dragged onto the schematic between two existing components. The product itself will identify the appropriate relationship and automatically connect the wire to each of the component's connection points. Additionally, a component assembly is a family of component parts. Component assemblies can be dropped into a drawing space just as an individual component can, but has the added advantage of including all the associated configured accessories (such as backshells, screw-locks and various other accessories. This decreases the time required to complete drawings and also increases design and pan consistency which reduces errors.

A centralized database 20 also maintains various methods of automatically numbering and identifying equipment and wires by assigning reference designators and wire numbers which are formatted to Aviation standards. The designators and numbers are physically labeled on each component and wire in the aircraft and also shown on the aircraft wiring diagram. Each identifier must be unique for all component parts and wires in the aircraft. The product maintains and assigns these identifiers in a format that is specific to the industry.

The present computer program product also identifies which component parts and pins are used in an electrical design within the explorer window 22. A user therefore does not have to search through drawings to identify which pins are utilized.

As referenced and illustrated above in FIG. 2, a master library 24 (stored on centralized database 20 on file server 14) holds a series of data (reference numeral) regarding component parts 26 unique to the aviation completion and modification industry. The master library communicates with the computer program product 10. Each component part 26 utilized within any of the schematic drawings 16 is derived from and linked to the master component part 26 and is automatically synchronized between the master library 24 and the component part 26 itself. If any attribute of the master component part 26 is updated then all components derived from the master component part 26 are automatically synchronized to the master component part 26 to reflect the change in attribute values (computer program product 10 effects the two-way communication between the workstation 12 and the centralized database 20). Thus, if a user desires to select a particular component part 26, that component is easy to find, utilize and implement in the totality of the overall electrical design. If a new component part 26 is entered, the data relating to the new part need only be entered once. The data relating to the new component part 26 is stored for use as many times as required on the present project or future projects. Additionally, changes made to specific equipment and wiring is automatically applied to all effected drawings to maintain consistency through the centralized database 20. While the present application is illustrated as having one or more separate servers and a workstation, it could be organized in any known manner. Computer program product 10 can also communicate on the World Wide Web in order to transmit information to another user or third party.

Tools are also included to automate drawing wire harness diagrams. Wire harness diagrams can be automatically generated by the computer program product based on electrical interconnection relationships from contained within the aircraft wiring diagrams. Additional wire harness tools are provided by the product to assist the end-user in efficiently drafting and validating the wire harness diagrams. Each project consists of multiple views of data included in multiple schematic drawings including component parts, wires and interconnections. Each component part may appear and/or each wire may have connections on multiple schematic drawings. The attributes of component part and/or wire must be consistent on each relevant schematic drawing. Using the present computer program product the attributes are only maintained on the centralized database 20 and not the drawing itself. Thus, if an attribute of a component part or wire connection is modified by one user on his/her drawing workspace 28, the component part or wire connection attribute is modified accordingly on centralized database 20. Thus, all data associated with elevant schematic drawings are automatically and simultaneously updated such that every user has the up-to-date consistent data relating to each component part and wiring connection.

Further, as the end-user provides inputs to the overall design system, the product automatically checks for errors within the electrical design. If an error is found the end-user is alerted to the specific error. This error check of the design is specific to aircraft wiring diagram design rules that automate manual processes used by the industry to check for design errors. The specific rules are written into an algorithm and as the data is shared with the centralized database (housing the overall electrical design) the algorithm runs the data thereby checking for any abnormality (or design error) across all drawings in a particular project concurrently If an error exists the program notifies the end-user the specific error for correction. Custom algorithms for specific end-users can be written based on specialized projects or requirements. The present product includes over 50 error checks specific to the avionics electrical design and could include many more.

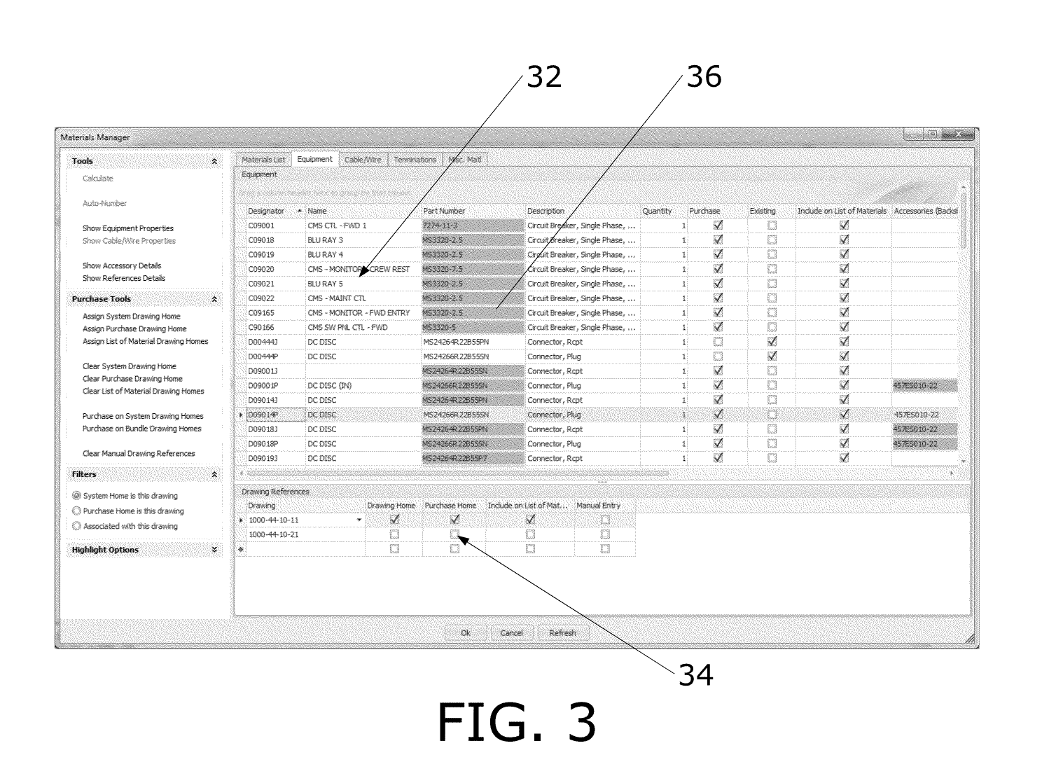

A material list 32 is automatically generated as the end-user drafts or modifies the schematic drawings 16. An example of a material list 32 is illustrated in FIG. 3. Material list 32 is derived from the component parts 26 and wires on a schematic drawing 16 which are required to be purchased and/or to build a system. As the component parts 26 and other aspects of the schematic drawing 16 are modified materials list 32 is synchronized across the entire project in a manner which is unique to the aviation completion and modification industry. Thus, while one circuit breaker may exist on three drawings, only one is listed on the materials list 32 and subsequently, a purchasing report. As illustrated, the materials list 32 allows the user to view all schematic drawings that contain any component part 26 and assign that particular component part 26 to a particular schematic drawing for purchasing purposes. Thus, the drawing reference interface 34 allows the user to select a series of parameters controlling the inclusion or exclusion of the component part 26 on the bill of materials and the drawing against which the part is ordered. Thereby the materials list 32 allows quick and efficient selection of the component parts 26.

The materials list 32 is provided in order to create a simplified and unique method of compiling all parts and/or purchases that will be needed for the specific project.

The product provides a wiring diagram data report that is unique. The product compiles all information necessary to build the electrical design. This information includes but is not limited to 1) Drawing List, 2) Equipment List, 3) Wire Stamp List, 4) Wire List, 5) Materials List 6) Location/Panel/Monument List, 7) Hookup List. The data may be compiled based on a single drawing, a set of drawings, a wire bundle assignment or a specific monument, panel or equipment container. Each component part of the system includes an input which encodes for particular purchasing information and material data. As the product synchronizes across all schematic drawings to compile the overall electrical design, the purchasing and material data is housed and synchronized in centralized database 20. Upon completion of the overall electrical design the end-user can run a series of reports which include all purchasing, material and equipment data that will be required to build the system.

The reporting functionality of the present computer program product permits data mining on all aspects of the stored data associated with the overall electrical design. Report formats are unique to the aviation completion/modification industry. The present computer program product provides a unique industry specific data set comprising a multitude of custom reports and drawings.

Reports 18, illustrated as an output of the system in FIG. 1, include, but are not limited to: a bill of materials, equipment list, wire list, hookup list, bundle list, wire stamp list, drawing list, drawing change list and the aircraft wiring diagrams. In prior art programs, this information was placed within the field of wiring diagrams themselves as text or notes. The present program is unique in that it separates these lists from the drawings themselves and generates them in an automated manner as an attachment to the drawing. This improves efficiency over traditional methodologies.

These reports can be provided directly to a third party, such as purchasing and manufacturing entities, among others. There are many reports that can he created based on data collected and stored by the present program. For purposes of clarity and brevity all possible reports are not listed within the present description.

All reports include historical data relating to any revision made to the relevant data contained in a particular report. FIG. 6 a representative report providing an indicator 36 (in the present case, a highlighted cell) illustrating a change in data within the overall electrical design that caused a modification to the report. The report shows both the new data and the prior version data for comparison purposes.

Returning to FIG. 1, the data structure utilized includes interconnected servers which provide physical information within the wiring diagrams and the processes used to create or modify the aircraft electrical system within the aviation completion and modification industry.

User interface windows 22, as illustrated FIG. 2-4, shows the data organized and presented to the end-user based on the process used within the aviation modification industry. The user interface features a method that organizes the electrical design data in a manner that provides the end user with the ability to traverse the aircraft electrical design (drawings, components, wires, and their relationships) from a hierarchical tree structure. This tree structure mirrors the way that the components, wires and their relationships are contained within the various electrical drawings that represent the overall electrical design. User interface windows 22 organize the design information in a way that is unique to the aircraft completion/modification industry.

The general process of the computer program product allows an aircraft completion and modification center to more efficiently and effectively bring a project from start to finish, reducing redundant work, errors and manual tasks of not only the electrical engineers, but of every department involved in the completion of the project. Thus, a user operating from a workstation generates a plurality of schematic drawings that represent the aircraft electrical design. These drawing files are linked via a centralized database and are kept on a network share that is accessible to all engineers working on the project. Thus, multiple users, particularly engineers at this stage of the process, can be involved in one project, taking advantage of the synchronization techniques previously described. As each electrical system design is created/modified by the engineer, the program synchronizes all other related drawings and the overall electrical design stored within the centralized database. After each drawing modification, the system runs a design analysis to provide indication of design errors to the end-users (similar to spell check). As previously discussed at the close of a project numerous reports can be generated. Importantly, other departments such as purchasing, manufacturing and production may require read-only access to the project to view or run reports relevant to bring the project to completion.

The preceding description contains significant detail regarding the novel aspects of the present invention, it should not be construed, however, as limiting the scope of the invention but rather as providing illustrations of the preferred embodiments of the invention. As an example, the steps of the process can be somewhat modified.

Having described our invention, I claim:

1. A computer program product, comprising a non-transitory computer usable medium having a computer readable program code embodied thereon, said computer readable program code adapted to be executed to implement a method of designing and modifying aircraft electrical systems comprising:
a. an engineering workstation accessible to a user;
b. a centralized database capable of storing a series of schematic drawings and a master library having a library of component parts;
c. wherein said centralized database is accessible from said engineering workstation;
d. wherein said series of schematic drawings are capable of modification from said engineering workstation;
e. wherein said user can access said master library from said engineering workstation and utilize said master library to input a series of data into said series of schematic drawings; and
f. wherein said series of schematic drawings are synchronously updating said series of data on said centralized database.

2. The computer program product of claim 1, wherein said master library further comprises a series of data relating to said component parts wherein said series of data is synchronously updating as said user modifies said series of data on said engineering workstation.

3. The computer program product of claim 1, wherein said engineering workstation further comprises:
a. a user interface having:
i. a drawing workspace;
ii. an explorer window having said truster library; and
iii. a shape view workspace.

4. The computer program product of claim 3, wherein said drawing workspace further comprises a schematic drawing selected from said centralized database.

5. The computer program product of claim 4, wherein said master library further comprises component parts which are capable of being dragged and released onto said schematic drawing within said drawing workspace.

6. The computer program product of claim 3, wherein said explorer window further comprises a display of data in a hierarchical organization of expandable and collapsible component parts.

7. The computer program product of claim 6, wherein said component parts each have a set of data associated with said component part.

8. The computer program product of claim 3, wherein said master library comprises a component assembly comprised of a series of component parts.

9. The computer program product of claim 7, wherein when said user updates said set of data associated with said component part said set of data is synchronously updated in said centralized database.

10. The computer program product of claim 1, wherein when said schematic drawings are complete a series of reports can be run accessing said data stored in said master library.

11. The computer program product of claim 10, wherein said data stored on said centralized database can be merged into a single report for purposes of transmitting information to a third party.

12. A computer program product, comprising a non-transitory computer usable medium having a computer readable program code embodied thereon, said computer readable program code adapted to be executed to implement a method of designing and modifying aircraft electrical systems comprising:
a. an engineering workstation accessible to a user;
b. a centralized database capable of storing a series of schematic drawings and a master library having a library of component parts;
c. wherein said centralized database is accessible from said engineering workstation;
d. wherein said series of schematic drawings are capable of modification from said engineering workstation;
e. wherein said user can access said master library from said engineering workstation and utilize said master library to input a series of data into said series of schematic drawings; and
f. wherein said series of schematic drawings are synchronously updating said series of data on said centralized database;
g. an error-checking function capable of identifying errors in said series of data inputted by said user and providing an alert to said user regarding said error.

13. The computer program product of claim 12, wherein said centralized database also stores a series of electronic symbols, a series of reference designators add a series of wire numbering.

14. The computer program product of claim 12, wherein said master library further comprises a series of data relating to said component parts wherein said series of data is synchronously updating as said user modifies said series of data on said engineering workstation.

15. The computer program product of claim 12, wherein said engineering workstation further comprises:
a. a user interface having:
i. a drawing workspace;
ii. an explorer window having said master library; and
iii. a shape view workspace.

16. The computer program product of claim 15, wherein said drawing workspace further comprises a schematic drawing selected from said centralized database.

17. The computer program product of claim 16, wherein said master library further comprises component parts which are capable of being dragged and released onto said schematic drawing within said drawing workspace.

18. The computer program product of claim 15, wherein said explorer window further comprises a display of data in a hierarchical organization of expandable and collapsible component parts.

19. The computer program product of claim 18, wherein said component parts each have a set of data associated with said component part.

20. The computer program product of claim 15, wherein said master library further comprises a component assembly comprised of a series of component parts.
